(19) United States
(12) Patent Application Publication
(10) Pub. No.: US 2024/0145759 A1
(43) Pub. Date: May 2, 2024

(54) LITHIUM SECONDARY BATTERY

(71) Applicant: SK ON CO., LTD., Seoul (KR)

(72) Inventor: Gyu Duk MIN, Daejeon (KR)

(21) Appl. No.: 18/349,172

(22) Filed: Jul. 10, 2023

(30) Foreign Application Priority Data
Oct. 26, 2022 (KR) 10-2022-0139166

(51) Int. Cl. H01M 10/052; H01M 4/04

(52) U.S. Cl. CPC H01M 10/052; H01M 4/0404; H01M 2004/021

(57) ABSTRACT

A lithium secondary battery according to an embodiment of the present invention may include an electrode assembly in which a plurality of cathodes and a plurality of anodes are alternately and repeatedly laminated. Depending on positions of the cathodes and anodes, a loading weight of a cathode active material layer and a specific capacity of the cathode active material, and a loading weight of an anode active material layer and a specific capacity of the anode active material may be different.

### CROSS-REFERENCE TO RELATED APPLICATION AND CLAIM OF PRIORITY

This application claims priority to Korean Patent Application No. 10-2022-0139166 filed on Oct. 26, 2022 in the Korean Intellectual Property Office (KIPO), the entire disclosure of which is incorporated by reference herein.

### BACKGROUND OF THE INVENTION

### 1. Field of the Invention

The present invention relates to a lithium secondary battery.

### 2. Description of the Related Art

A secondary battery is a battery which can be repeatedly charged and discharged, and has been widely applied to portable electronic devices such as a mobile phone, a laptop computer, electric vehicles and other electronic or electrical apparatuses as a power source thereof.

A lithium secondary battery has a high operating voltage and a high energy density per unit weight, and is advantageous in terms of a charging speed and light weight. In this regard, the lithium secondary battery has been actively developed and applied as a power source.

For example, the lithium secondary battery may include a plurality of cathodes and a plurality of anodes, which are alternately and repeatedly laminated. A liquid electrolyte (in this case, a separation membrane may be further included to prevent a short circuit between the cathode and the anode) or a solid electrolyte may be present between the cathode and the anode for the movement of lithium ions.

The cathode may include a cathode current collector, and a cathode active material layer formed on the cathode current collector and including a cathode active material. The anode may include an anode current collector, and an anode active material layer formed on the anode current collector and including an anode active material.

The cathode active material and the anode active material may reversibly intercalate and deintercalate lithium ions. Accordingly, as intercalation and deintercalation of lithium ions are repeated between the cathode active material and the anode active material, the lithium secondary battery may be charged and discharged.

Meanwhile, when repeatedly charging and discharging the lithium secondary battery, heat may be generated due to an electrochemical reaction. The heat generation may cause a deterioration in the performance (e.g., life-span characteristics) of the battery.

### SUMMARY OF THE INVENTION

An object of the present invention is to provide a lithium secondary battery having improved electrochemical performance (e.g., capacity, energy density, etc.) and operational reliability (e.g., life-span characteristics).

To achieve the above object, according to an aspect of the present invention, there is provided a lithium secondary battery including: an electrode assembly including a plurality of cathodes and a plurality of anodes, which are alternately and repeatedly laminated; and a case in which the electrode assembly is housed.

Each of the plurality of cathodes comprises a cathode current collector, and a cathode active material layer formed on the cathode current collector and including a cathode active material. The plurality of cathodes comprise a central cathode located at or adjacent to a center area of the electrode assembly in a thickness direction, and outermost cathodes located farthest from the center area of the electrode assembly. The center area of the electrode assembly refers to an area at and around the center of the electrode assembly in the thickness direction among the plurality of cathodes.

Each of the plurality of anodes comprises an anode current collector, and an anode active material layer formed on the anode current collector and including an anode active material, the plurality of anodes comprise a central anode adjacent to the center area of the electrode assembly in the thickness direction, and outermost anodes located farthest from the center area of the electrode assembly in the thickness direction among the plurality of anodes.

A loading weight (LWC₁) of a cathode active material layer of the central cathode is greater than a loading weight (LWCₘ) of a cathode active material layer of the outermost cathode, and a specific capacity (SCC₁) of a cathode active material in the cathode active material layer of the central cathode is smaller than a specific capacity (SCCₘ) of a cathode active material in the cathode active material layer of the outermost cathode.

A loading weight (LWA₁) of an anode active material layer of the central anode is greater than a loading weight (LWAₙ) of an anode active material layer of the outermost anode, and a specific capacity (SCA₁) of an anode active material in the anode active material layer of the central anode is smaller than a specific capacity (SCAₙ) of an anode active material in the anode active material layer of the outermost anode.

In an embodiment, a ratio of LWCₘ to LWC₁ may be 0.6 to 0.9.

In an embodiment, a ratio of SCCₘ to SCC₁ may be 1.1 to 5.

In an embodiment, a ratio of a value of LWCₘ×SCCₘ to a value of LWC₁×SCC₁ may be 0.7 to 1.3.

In an embodiment, the cathode active material layer of the central cathode may include: a first cathode active material layer formed on a cathode current collector of the central cathode and including a first cathode active material; and a second cathode active material layer formed on the first cathode active material layer and including a second cathode active material, wherein a specific capacity (SCC₁₋₁) of the first cathode active material may be greater than a specific capacity (SCC₁₋₂) of the second cathode active material.

In an embodiment, a ratio of SCCₘ to SCC₁₋₁ may be 0.95 to 1.05, and a ratio of SCC₁₋₂ to SCCₘ may be 0.1 to 0.9.

In an embodiment, the case may include a first surface and a second surface, which face each other in the thickness direction of the electrode assembly, the plurality of cathodes comprise a single or a pair of first cathodes to a pair of m-th cathodes, which are arranged in both directions from the center area of the electrode assembly in the thickness direction toward the first surface and the second surface of the case (provided that m is an integer of 3 or more), the first cathode may be the central cathode, and the m-th cathodes may be the outermost cathodes.

In an embodiment, the plurality of cathodes may satisfy Equation 1-1 below:

LWC₁>. . . >LWCₖ₋₁>LWCₖ [Equation 1-1]
wherein in Equation 1-1, LWCₖ is a loading weight of a cathode active material layer of a k-th cathode, and k is an integer from 2 to m).

In an embodiment, the plurality of cathodes may satisfy Equation 3-1 below:

SCC₁<. . . <SCCₖ₋₁<SCCₖ Equation 3-1
wherein in Equation 3-1, SCCₖ is a specific capacity of a cathode active material included in the cathode active material layer of the k-th cathode, and k is an integer from 2 to m).

In an embodiment, the plurality of cathodes may satisfy Equation 5-2 below:

0.7×(LWC₁×SCC₁)≤LWCₖ×SCCₖ≤1.3×(LWC₁×SCC₁) Equation 5-2
wherein in Equation 5-2, LWCₖ is the loading weight of the cathode active material layer of the k-th cathode, SCCₖ is the specific capacity of the cathode active material included in the cathode active material layer of the k-th cathode, k is an integer from 2 to m, and m is an integer of 3 or more).

In an embodiment, a ratio of LWAₙ to LWA₁ may be 0.1 to 0.9.

In an embodiment, a ratio of SCAₙ to SCA₁ may be 1.1 to 10.

In an embodiment, a ratio of a value of LWAₙ×SCAₙ to a value of LWA₁×SCA₁ may be 0.7 to 1.3.

In an embodiment, the anode active material layer of the central anode may include: a first anode active material layer formed on an anode current collector of the central anode and including a first anode active material; and a second anode active material layer formed on the first anode active material layer and including a second anode active material; wherein a specific capacity (SCA₁₋₁) of the first anode active material may be greater than a specific capacity (SCA₁₋₂) of the second anode active material.

In an embodiment, a ratio of SCAₙ to SCA₁₋₁ may be 0.95 to 1.05, and a ratio of SCA₁₋₂ to SCAₙ may be 0.1 to 0.9.

In an embodiment, the case may include a first surface and a second surface, which face each other in the thickness direction of the electrode assembly, the plurality of anodes comprise a single or a pair of first anodes to a pair of the n-th anodes, which are arranged in both directions from the center area of the electrode assembly in the thickness direction toward the first surface and the second surface of the case (provided that n is an integer greater of 3 or more), the first anode may be the central anode, and the n-th anodes may be the outermost anodes.

In an embodiment, the plurality of anodes may satisfy Equation 2-1 below:

LWA₁>. . . >LWAₖ₋₁>LWAₖ Equation 2-1
wherein in Equation 2-1, LWAₖ is a loading weight of an anode active material layer of a k-th anode, and k is an integer from 2 to n.

In an embodiment, the plurality of anodes may satisfy Equation 4-1 below:

SCA₁<. . . <SCAₖ₋₁<SCAₖ Equation 4-1
wherein in Equation 4-1, SCAₖ is a specific capacity of an anode active material included in the anode active material layer of the k-th anode, and k is an integer from 2 to n.

In an embodiment, the plurality of anodes may satisfy Equation 6-2 below:

0.7×(LWA₁×SCA₁)≤LWAₖ×SCAₖ≤1.3×(LWA₁×SCA₁) Equation 6-2
wherein in Equation 6-2, LWAₖ is the loading weight of the anode active material layer of the k-th anode, SCAₖ is the specific capacity of the anode active material included in the anode active material layer of the k-th anode, k is an integer from 2 to n, and n is an integer of 3 or more.

According to an embodiment of the present invention, it is possible to provide a lithium secondary battery having improved heat suppression performance, life-span characteristics, and rapid charging performance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic plan view illustrating a lithium secondary battery according to an embodiment; and

FIG. 2 is a cross-sectional view of the lithium secondary battery taken on line I-I′ in FIG. 1.

### DETAILED DESCRIPTION OF THE INVENTION

According to an embodiment of the present invention, there may be provided a lithium secondary battery having improved electrochemical performance and operational reliability by adjusting a loading weight of the electrode active material layer and/or a specific capacity of the electrode active material depending on positions of the electrodes.

As used herein, the term “thickness direction” of an electrode assembly may refer to a direction in which cathodes and anodes are laminated.

Hereinafter, a lithium secondary battery according to an embodiment of the present invention will be described in detail with reference to the drawings. However, the drawings and embodiments are merely an example, and the present invention is not limited thereto.

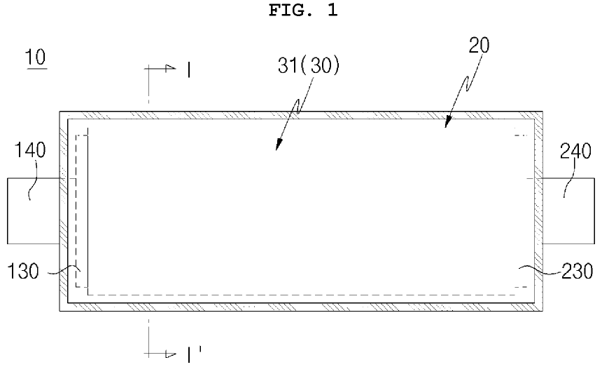

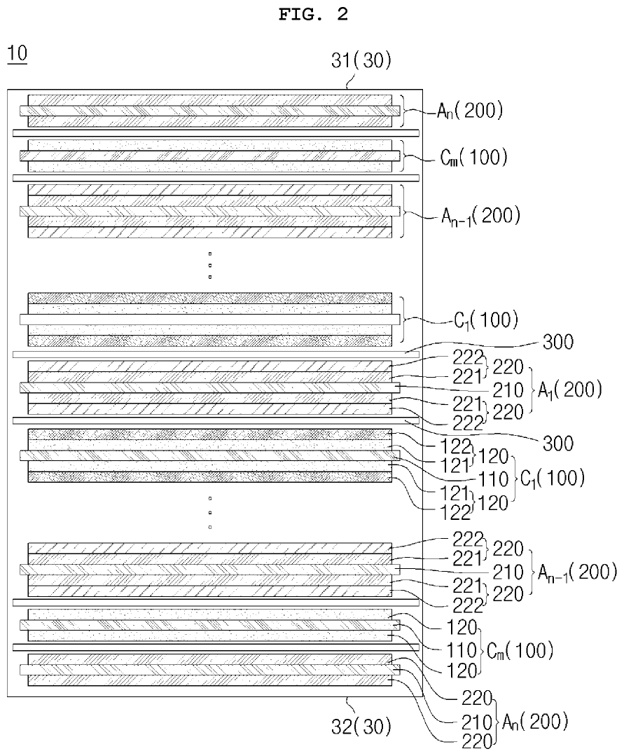

FIG. 1 is a plan view schematically illustrating a lithium secondary battery 10 according to an embodiment, and FIG. 2 is a cross-sectional view of the lithium secondary battery 10 taken on line I-I′ in FIG. 1.

Referring to FIGS. 1 and 2, the lithium secondary battery 10 may include an electrode assembly 20 and a case 30 in which the electrode assembly 20 is housed.

Referring to FIG. 2, the electrode assembly 20 may include a plurality of cathodes 100 and a plurality of anodes 200, which are alternately laminated.

The case 30 may include a first surface 31 and a second surface 32, which face each other in the thickness direction of the electrode assembly 20.

The plurality of cathodes 100 may include a single or a pair of first cathodes C₁ to a pair of m-th cathodes Cₘ (provided that m is an integer of 2 or more), which are arranged in both directions from a center area of the electrode assembly 20 in the thickness direction (hereinafter, may be abbreviated as a center area of the electrode assembly) toward the first surface 31 and the second surface 32 of the case.

In an embodiment, m in Cₘ may be 2 or more, 3 or more, 5 or more, or 10 or more. Further, m may be 200 or less, 100 or less, 90 or less, 80 or less, 70 or less, 60 or less, 50 or less, 40 or less, 30 or less, or 20 or less.

The plurality of anodes 200 may include a single or a pair of first anodes A₁ to a pair of the n-th anodes Aₙ (provided that n is an integer of 2 or more), which are arranged in the both directions.

In an embodiment, n in Aₙ may be 2 or more, 3 or more, 5 or more, or 10 or more. Further, n may be 100 or less, 90 or less, 80 or less, 70 or less, 60 or less, 50 or less, 40 or less, 30 or less, or 20 or less.

According to an embodiment, in Cₘ and Aₙ, m=n or m=n−1.

The first cathode C₁ may be at or adjacent to the center area of the electrode assembly 20, and may be defined as a central cathode. For example, the first cathode C₁ may be located at the center area of the electrode assembly 20. In an embodiment, the first cathode C₁ may be a cathode located closest to the center area of the electrode assembly 20 among the cathodes.

The first anode A₁ may be at or adjacent to the center area of the electrode assembly 20, and may be defined as a central anode. For example, the first anode A₁ may be located at the center area of the electrode assembly 20. In an embodiment, the first anode A₁ may be an anode located closest to the center area of the electrode assembly 20 among the anodes.

The pair of m-th cathodes Cₘ may be cathodes located farthest from the center area of the electrode assembly 20 in both directions, and may be defined as the outermost cathodes. For example, one of the pair of the m-th cathodes Cₘ may be adjacent to the first surface 31 and the other one of the pair of the m-th cathodes Cₘ may be adjacent to the second surface 32 of the case, respectively. For example, among the plurality of the cathodes, the pair of the m-th cathodes Cₘ may be located closest to the first surface 31 and the second surface 32 of the case, respectively.

Among the cathodes, cathodes (e.g., the first cathode C₁ to m−1-th cathode Cₘ₋₁) except for the pair of the m-th cathodes Cₘ (which are referred to also as the outermost cathodes) may be referred to as inner cathodes.

The pair of the n-th anodes Aₙ may be anodes located farthest from the center area of the electrode assembly 20 in both directions, and may be defined as the outermost anodes. For example, one of the pair of the n-th anodes Aₙ may be adjacent to the first side 31 and the other one of the pair of the n-th anodes Aₙ may be adjacent to the second side 32 of the case, respectively.

Among the plurality of the anodes, the anodes (e.g., the first anode A₁ to n−1-th anode Aₙ₋₁) except for the pair of the outermost n-th anodes Aₙ may also be referred to as inner anodes.

In an embodiment like the one illustrated in FIG. 2, the pair of the n-th anodes Aₙ may be the outermost electrodes. For example, among all the electrodes, the pair of the n-th anodes Aₙ may be the electrodes located farthest from the center area of the electrode assembly 20 in the thickness direction. For example, among all the electrodes, the pair of the n-th anodes Aₙ may be located closest to the first surface 31 and the second surface 32 of the case, respectively.

Each of the plurality of cathodes 100 may include a cathode current collector 110 and a cathode active material layer 120 on the cathode current collector 110.

For example, as illustrated in the embodiment of FIG. 2, the cathode active material layer 120 may be formed on one surface or both surfaces of the cathode current collector 110.

The cathode current collector 110 may include, for example, stainless steel, nickel, aluminum, titanium, copper, or an alloy thereof.

The cathode active material layer 120 may include a cathode active material capable of reversibly intercalating and deintercalating lithium ions.

In an embodiment, the cathode active material may include lithium metal oxide particles. For example, the lithium metal oxide particles may include lithium cobalt oxide particles (LCOs), lithium manganese oxide particles (LMOs), lithium nickel oxide particles (LNOs), lithium nickel-cobalt-manganese oxide particles (NCMs), lithium nickel-cobalt-aluminum oxide particles (NCAs), lithium nickel-cobalt-manganese-aluminum oxide particles (NCMAs), lithium phosphate-iron particles (LFPs), lithium phosphate-iron-manganese particles (LFMPs), over-lithiated oxide particles (OLOs) and the like. These may be used alone or in combination of two or more thereof.

In an embodiment, the lithium metal oxide particles may include lithium metal oxide particles represented by Formula 1, Formula 2, or Formula 3 below.

LiₓNi_{(1-a-b)}M1ₐM2_{b}O_{y} Formula 1

In Formula 1, M1 and M2 may be each independently at least one of Co, Mn, Al, Zr, Ti, Cr, B, Mg, Mn, Ba, Si, Y, W and Sr, and x, y, a and b may be in a range of 0.9≤x≤1.1, 1.9≤y≤2.1, and 0≤a+b≤0.5, respectively.

In an embodiment, a and b may satisfy 0<a+b≤0.4, 0<a+b≤0.3 or 0<a+b≤0.2.

LiFe₁₋ₓMₓPO₄ Formula 2

In Formula 2, M may be at least one of Ni, Co, Mn, Al, Mg, Y, Zn, In, Ru, Sn, Sb, Ti, Te, Nb, Mo, Cr, Zr, W, Ir and V, and x may satisfy 0≤x<1.

xLi₂MnO₃*(1-x)LiMeO₂, Formula 3

In Formula 3, Me may be at least one of Ni, Mn, Co, Mg, V, Ti, A₁, Fe, Ru, Zr, W, Sn, Nb and Mo, and x may satisfy 0.05≤x≤0.7.

The cathode active material layer 120 may include a binder and/or a conductive material.

In one embodiment, a content of the cathode active material of a total weight of the cathode active material layer 120 may be 80 by weight percent (“wt. %”) or more, 85 wt. % or more, or 90 wt. % or more.

In some embodiments, the content of the cathode active material of the total weight of the cathode active material layer 120 may be 99 wt. % or less, 97 wt. % or less, or 95 wt. % or less.

Each of the plurality of anodes 200 may include an anode current collector 210 and an anode active material layer 220 on the anode current collector 210.

For example, the anode active material layer 220 may be formed on one surface or both surfaces of the anode current collector 210.

In an embodiment, the anode current collector 210 may include gold, stainless steel, nickel, aluminum, titanium, copper, or an alloy thereof.

In an embodiment, the anode active material layer 220 may include an anode active material capable of reversibly intercalating and deintercalating lithium ions.

In an embodiment, the anode active material may include a lithium alloy, a carbon-based anode active material, a silicon-based anode active material or the like. These may be used alone or in combination of two or more thereof.

In an embodiment, the lithium alloy may include aluminum, zinc, bismuth, cadmium, antimony, silicon, lead, tin, gallium, indium and the like.

In an embodiment, the carbon-based anode active material may include crystalline carbon, amorphous carbon, carbon composite material, carbon fiber and the like. For example, the amorphous carbon may include hard carbon, cokes, mesocarbon microbead, mesophase pitch-based carbon fiber and the like. For example, the crystalline carbon may include natural graphite, graphite cokes, graphite MCMB, graphite MPCF or the like.

In an embodiment, the silicon-based anode active material may include Si, SiOₓ (0<x<2), an Si/C composite, an SiO/C composite or the like. For example, the Si/C composite may include Si particles and a carbon-based coating layer formed on the surfaces of the Si particles. In an embodiment, the Si/C composite may include porous carbon-based particles and Si coating layers formed on pores and/or surfaces of the porous carbon-based particles. The Si/C composite may, for example, be a silicon-graphite composite. Preparation of such Si/C composites is well-known in the art and need not be repeated herein.

In an embodiment, the anode active material layer 220 may further include a binder and/or a conductive material.

In an embodiment, a content of the anode active material of a total weight of the anode active material layer 220 may be 80 wt. % or more, 85 wt. % or more, or 90 wt. % or more.

In an embodiment, the content of the anode active material of the total weight of the anode active material layer 220 may be 99 wt. % or less, 97 wt. % or less, or 95 wt. % or less.

For example, as the binder and the conductive material, those known in the art may be used.

In an embodiment, the binder may include an organic binder such as polyvinylidene fluoride (PVDF), vinylidene fluoride-hexafluoropropylene copolymer, polyacrylonitrile, or polymethyl methacrylate, etc.; or an aqueous binder such as styrene-butadiene rubber (SBR). In addition, the binder may be used together with a thickener such as carboxymethyl cellulose (CMC).

In an embodiment, the conductive material may include a carbon-based conductive material such as graphite, carbon black, graphene, carbon nanotubes (CNTs), etc.; a metal-based conductive material such as tin, tin oxide, titanium oxide, or a perovskite material such as LaSrCoO₃, and LaSrMnO₃, etc.

According to an embodiment, a loading weight of the cathode active material layer 120 of the central cathode C₁ may be greater than a loading weight of the cathode active material layer 120 of the outermost cathodes Cₘ.

According to an embodiment, the loading weight of the anode active material layer 220 of the central anode A₁ may be greater than the loading weight of the anode active material layer 220 of the outermost anodes Aₙ.

The “loading weight” of an electrode active material layer is a weight (g/cm²) of the electrode active material layer per unit area of the electrode current collectors 110 and 210. Hence, the “loading weight” of the electrode active material layer 120 is the weight (g/cm²) of the electrode active material layer 120 per unit area of the electrode current collector 110, and the “loading weight” of the electrode active material layer 220 is the weight (g/cm²) of the electrode active material layer 220 per unit area of the electrode current collector 120.

In the lithium secondary battery, the central portion (e.g., in the vicinity of C₁ and A₁) and the outer portion (e.g., in the vicinity of Cₘ and Aₙ) of the electrode assembly 20 may have different resistances and heat generation values. Accordingly, the degree of deterioration of the electrodes may be non-uniform during operation of the battery, such that the life-span characteristics of the battery may be rapidly reduced.

According to an embodiment, by differently adjusting the loading weights of the electrode active material layers 120 and 220 of the central cathode C₁ and the central anode A₁ and the loading weights of the electrode active material layers 120 and 220 of the outermost cathode Cₘ and the outermost anode Aₙ as described above, it is possible to alleviate the non-uniformity in deterioration of the electrodes during operation of the battery and improve the life-span characteristics of the battery.

In an embodiment, a ratio of the loading weight of the cathode active material layer 120 of the outermost cathode Cₘ to the loading weight of the cathode active material layer 120 of the central cathode C₁ may be from 0.1 or more to less than 1, from 0.2 or more to less than 0.98, from 0.3 or more to less than 0.96, from 0.4 or more to less than 0.94, from 0.5 or more to less than 0.92, from 0.6 or more to less than 0.9, and from 0.7 or more to less than 0.88. Within the above range of the ratio of the loading weight, the life-span characteristics of the battery may be further improved. For example, the loading weight of the cathode active material layer 120 may be adjusted by regulating the thickness and/or density of the cathode active material layer 120.

In an embodiment, a ratio of the loading weight of the anode active material layer 220 of the outermost anode Aₙ to the loading weight of the anode active material layer 220 of the central anode A₁ may be 0.1 or more to less than 1, from 0.1 or more to less than 0.9, from 0.2 or more to less than 0.85, from 0.3 or more to less than 0.8, from 0.4 or more to less than 0.75, or from 0.5 or more to less than 0.7. In an embodiment, the ratio may be from 0.5 or more to less than 0.9, from 0.5 or more to less than 0.85, or from 0.5 or more to less than 0.8. Within the above range of the ratio of the loading weight, the life-span characteristics of the battery may be further improved. For example, the loading weight of the anode active material layer 220 may be adjusted by regulating the thickness and/or density of the anode active material layer 220.

According to an embodiment, in the plurality of cathodes 100, the loading weight of the cathode active material layer 120 may have a tendency of being decreased in a direction from the central cathode C₁ to the outermost cathodes Cₘ.

In an embodiment, the loading weight of the cathode active material layer 120 may be gradually decreased in the direction from the central cathode C₁ to the outermost cathodes Cₘ in an entire region between the central cathode C₁ and the outermost cathodes Cₘ.

For example, the plurality of cathodes 100 may satisfy Equation 1-1 below.

LWC₁>. . . >LWCₖ₋₁>LWCₖ Equation 1-1

In Equation 1-1, LWCₖ (provided that k is an integer from 2 to m) is a loading weight of a cathode active material layer of a k-th cathode, and m is an integer of 3 or more.

In an embodiment, the loading weight of the cathode active material layer 120 may be decreased in the direction from the central cathode C₁ to the outermost cathodes Cₘ only in a specific part of the region between the central cathode C₁ and the outermost cathodes Cₘ.

For example, at least one x-th cathode among the central cathode C₁ to the outermost cathodes Cₘ may satisfy Equation 1-2 below, and at least one y-th cathode may satisfy Equation 1-3 below. Accordingly, an energy density of the battery may be further improved.

LWCₓ>LWCₓ₊₁ Equation 1-2

LWC_{y}=LWC_{y-1} Equation 1-3

In Equations 1-2 and 1-3, LWCₓ, LWCₓ₊₁, LWC_{y} and LWC_{y+1} are a loading weight of the cathode active material layer of the x-th cathode, a loading weight of a cathode active material layer of an x+1-th cathode, a loading weight of the cathode active material layer of the y-th cathode, and a loading weight of a cathode active material layer of a y+1-th cathode, respectively, and x and y are independently an integer from 1 to m−1, provided that x and y are not the same as each other.

In an embodiment, the inner cathodes (i.e., the first cathode C₁ to the m−1-th cathode Cₘ₋₁) may have substantially the same loading weight of the cathode active material layer 120 as each other. In this case, the capacity of the battery may be further improved.

According to an embodiment, in the plurality of anodes 200, the loading weight of the anode active material layer 220 may have a tendency of being decreased in a direction from the central anode A₁ to the outermost anodes Aₙ.

In an embodiment, the loading weight of the anode active material layer 220 may be gradually decreased in a direction from the central anode A₁ to the outermost anodes Aₙ in an entire region between the central anode A₁ and the outermost anodes Aₙ.

For example, the plurality of anodes 200 may satisfy Equation 2-1 below.

LWA₁>. . . >LWAₖ₋₁>LWAₖ Equation 2-1

In Equation 2-1, LWAₖ (provided that k is an integer from 2 to n) is a loading weight of an anode active material layer of a k-th anode, and n is an integer of 3 or more.

In an embodiment, the loading weight of the anode active material layer 220 may be decreased in the direction from the central anode A₁ to the outermost anodes Aₙ only in a specific part of the region between the central anode A₁ and the outermost anodes Aₙ.

For example, at least one x-th anode among the central anode A₁ to the outermost anodes Aₙ may satisfy Equation 2-2 below, and at least one y-th anode may satisfy Equation 2-3 below. Accordingly, the energy density of the battery may be further improved.

LWAₓ>LWAₓ₊₁ Equation 2-2

LWA_{y}=LWA_{y+1} [Equation 2-3]

In Equations 2-2 and 2-3, LWAₓ, LWAₓ₊₁, LWA_{y} and LWA_{y+1} are a loading weight of the anode active material layer of the x-th anode, a loading weight of an anode active material layer of an x+1-th anode, a loading weight of the anode active material layer of the y-th anode, and a loading weight of an anode active material layer of a y+1-th anode, respectively, and x and y are independently an integer from 1 to n−1, provided that x and y are not the same as each other.

However, in Equations 1-3 and 2-3, “=” means the case of being substantially the same as each other, and a case, in which there is a slight difference in the process (e.g., a difference of less than 1% for a larger value or less than 0.5%), may also correspond to “=.”

In an embodiment, the inner anodes (i.e., the first anode A₁ to the n−1-th anode Aₙ−1) may have substantially the same loading weight of the anode active material layer 220 as each other. In this case, the capacity of the battery may be further improved.

In an embodiment, a specific capacity of the cathode active material included in the cathode active material layer 120 of the central cathode C₁ may be smaller than a specific capacity of the cathode active material included in the cathode active material layer 120 of the outermost cathode Cₘ.

In an embodiment, the specific capacity of the anode active material included in the anode active material layer 220 of the central anode A₁ may be smaller than the specific capacity of the anode active material included in the anode active material layer 220 of the outermost anode Aₙ.

The “specific capacity” of an electrode active material may refer to a capacity per unit weight of the electrode active material, or (mAh/g). In an embodiment, the specific capacity of the electrode active material may refer to a utilization capacity (i.e., reversible capacity) in a predetermined driving voltage range of the battery.

Meanwhile, as the specific capacity of the electrode active material is increased, the energy density of the battery may be improved. However, when the specific capacity of the electrode active material is high, a volume change rate of the electrode active material may be increased because the amount of lithium ions intercalated and deintercalated from the electrode active material during operation of the battery is increased. Accordingly, pulverization and deintercalation of the electrode active material may occur during operation of the battery, and life-span characteristics of the battery may be reduced.

According to an embodiment, by including an electrode active material having a relatively high specific capacity in the outermost electrodes Cₘ or Aₙ with a relatively small loading weight of the electrode active material, the volume change rate of the entire battery may be uniformly adjusted. Accordingly, the energy density of the battery may be improved, and a reduction in the life-span characteristics due to the volume change rate may be prevented. In addition, a rapid charging performance of the battery may be improved.

In an embodiment, a ratio of the specific capacity of the cathode active material included in the cathode active material layer 120 of the outermost cathode Cₘ to the specific capacity of the cathode active material included in the cathode active material layer 120 of the central cathode C₁ is greater than 1, 1.05 or more, 1.1 or more, or 1.15 or more. In addition, the ratio may be 5 or less, 4.5 or less, 4 or less, or 3 or less. In this case, the life-span characteristics of the battery may be further improved.

In an embodiment, a ratio of the specific capacity of the anode active material included in the anode active material layer 220 of the outermost anode Aₙ to the specific capacity of the anode active material included in the anode active material layer 220 of the central anode A₁ is greater than 1, 1.1 or more, 1.2 or more, 1.5 or more, 1.8 or more, or 2 or more. In addition, the ratio may be 10 or less, 9 or less, 8 or less, or 7.5 or less. In this case, the life-span characteristics of the battery may be further improved.

According to an embodiment, in the plurality of cathodes 100, the specific capacity of the cathode active material may have a tendency of being decreased in a direction from the outermost cathodes Cₘ to the central cathode C₁.

In an embodiment, in the entire region between the central cathode C₁ and the outermost cathodes Cₘ, the specific capacity of the cathode active material included in the cathode active material layer 120 may be decreased in the direction from the outermost cathodes Cₘ to the central cathode C₁.

For example, the plurality of cathodes 100 may satisfy Equation 3-1 below.

SCC₁<. . . <SCCₖ₋₁<SCCₖ Equation 3-1

In Equation 3-1, SCCₖ (provided that k is an integer from 2 to m) is a specific capacity of a cathode active material included in the cathode active material layer of the k-th cathode, and m is an integer of 3 or more.

In an embodiment, only in a specific part of the region between the central cathode C₁ and the outermost cathodes Cₘ, the specific capacity of the cathode active material may be decreased in the direction from the outermost cathodes Cₘ to the central cathode C₁.

For example, at least one x-th cathode among the central cathode C₁ to the outermost cathodes Cₘ may satisfy Equation 3-2 below, and at least one y-th cathode may satisfy Equation 3-3 below. In this case, the capacity and life-span characteristics of the battery may be further improved.

SCCₓ<SCCₓ₊₁ Equation 3-2

SCC_{y}=SCC_{y+1} Equation 3-3

In Equations 3-2 and 3-3, SCCₓ, SCCₓ₊₁, SCC_{y}, and SCC_{y+1} are a specific capacity of the cathode active material of the x-th cathode, a specific capacity of the cathode active material of the x+1-th cathode, a specific capacity of the cathode active material of the y-th cathode, and a specific capacity of the cathode active material of the y+1-th cathode, and x and y are independently an integer from 1 to m−1, provided that, x and y are not the same as each other.

In an embodiment, specific capacities of cathode active materials included in each of the inner cathodes (e.g., the first cathode C₁ to the m−1-th cathode Cₘ₋₁) may be substantially the same as each other. In this case, the capacity of the battery may be further improved.

In an embodiment, the cathode active material layer 120 of the plurality of cathodes 100 may include lithium metal oxide particles containing nickel as a cathode active material. For example, the specific capacity of the cathode active material may be adjusted by regulating a mole fraction of nickel to all elements except for lithium and oxygen in the lithium metal oxide particles.

For example, the central cathode C₁ may include a cathode active material including first lithium metal oxide particles containing nickel, and the outermost cathode Cₘ may include a cathode active material including second lithium metal oxide particles containing nickel. The mole fraction of nickel to the all elements except for lithium and oxygen in the second lithium metal oxide particles may be greater than the mole fraction of nickel to all elements except for lithium and oxygen in the first lithium metal oxide particles.

According to an embodiment, in the plurality of anodes 200, the specific capacity of the anode active material may have a tendency of being decreased in a direction from the outermost anodes Aₙ to the central anode A₁.

In an embodiment, in the entire region between the central anode A₁ and the outermost anodes Aₙ, the specific capacity of the anode active material included in the anode active material layer 220 may be decreased in the direction from the outermost anodes Aₙ to the central anode A₁.

For example, the plurality of anodes 200 may satisfy Equation 4-1 below.

SCA₁<. . . <SCAₖ₋₁<SCAₖ Equation 4-1

In Equation 4-1, SCAₖ (provided that k is an integer from 2 to n) is a specific capacity of the anode active material included in the anode active material layer of the k-th anode, and n is an integer of 3 or more.

In an embodiment, only in a specific part of the region between the central anode A₁ and the outermost anodes Aₙ, the specific capacity of the anode active material may be decreased in the direction from the outermost anodes Aₙ to the central anode A₁.

For example, at least one x-th anode among the central anode A₁ to the outermost anodes Aₙ may satisfy Equation 4-2 below, and at least one y-th anode may satisfy Equation 4-3 below. In this case, the capacity and life-span characteristics of the battery may be further improved.

SCAₓ<SCAₓ₊₁ Equation 4-2

SCA_{y}=SCA_{y+1} Equation 4-3

In Equations 4-2 and 4-3, SCAₓ, SCAₓ₊₁, SCA_{y}, and SCA_{y+1} are a specific capacity of the anode active material of the x-th anode, a specific capacity of the anode active material of the x+1-th anode, a specific capacity of the anode active material of the y-th anode, and a specific capacity of the anode active material of the y+1-th anode, and x and y are independently an integer from 1 to n−1, provided that x and y are not the same as each other.

However, in Equations 3-3 and 4-3, “=” means the case of being substantially the same as each other, and a case, in which there is a slight difference in the process (e.g., a difference of less than 1% for a larger value or less than 0.5%), may also correspond to “=.”

In an embodiment, the specific capacities of the anode active materials included in each of the inner anodes (e.g., the first anode A₁ to the n−1-th anode Aₙ₋₁) may be substantially the same as each other. In this case, the capacity of the battery may be further improved.

In an embodiment, the anode active material layer 220 of the plurality of anodes 200 may include a silicon-based anode active material as the anode active material. For example, the specific capacity of the anode active material may be adjusted by regulating the content (at. % or wt. %) of silicon atoms in the anode active material.

For example, the central anode A₁ may include a first anode active material including a silicon-based anode active material, and the outermost anode Aₙ may include a second anode active material including a silicon-based anode active material. A content of silicon atoms in a total weight of the second anode active material may be greater than a content of silicon atoms in the first anode active material.

In an embodiment, the central cathode C₁ and the outermost cathode Cₘ may satisfy Equation 5-1 below. In this case, the energy density and life-span characteristics of the battery may be further improved.

0.7×(LWC₁×SCC₁)≤LWCₘ×SCCₘ≤1.3×(LWC₁×SCC₁) Equation 5-1

In Equation 5-1, LWC₁ is the loading weight of the cathode active material layer 120 of the central cathode C₁, and LWCₘ is the loading weight of the cathode active material layer 120 of the outermost cathode Cₘ. Further, SCC₁ is the specific capacity of the cathode active material of the central cathode C₁, and SCCₘ is the specific capacity of the cathode active material of the outermost cathode Cₘ.

In an embodiment, a ratio of LWCₘ×SCCₘ to LWC₁×SCC₁ may be 0.75 or more and less than 1.3, 0.75 to 1.3, 0.75 to 1.25, 0.8 to 1.2, or 0.9 to 1.1.

In an embodiment, the plurality of cathodes 100 may satisfy Equation 5-2 below.

0.7×(LWC₁×SCC₁)≤LWCₖ×SCCₖ≤1.3×(LWC₁×SCC₁) Equation 5-2

In Equation 5-2, LWC₁ is the loading weight of the cathode active material layer 120 of the central cathode C₁, and LWCₖ is the loading weight of the cathode active material layer 120 of the k-th cathode. SCC₁ is the specific capacity of the cathode active material of the central cathode C₁, and SCCₖ is the specific capacity of the cathode active material of the k-th cathode. k is an integer from 2 to m, and m is an integer of 3 or more.

In an embodiment, a ratio of LWCₖ×SCCₖ to LWC₁×SCC₁ may be 0.75 or more and less than 1.3, 0.75 to 1.3, 0.75 to 1.25, 0.8 to 1.2, or 0.9 to 1.1.

In an embodiment, the central anode A₁ and the outermost anodes Aₙ may satisfy Equation 6-1 below. In this case, the energy density and life-span characteristics of the battery may be further improved.

0.7×(LWA₁×SCA₁)≤LWAₙ×SCAₙ≤1.3×(LWA₁×SCA₁) Equation 6-1

In Equation 6-1, LWA₁ is the loading weight of the anode active material layer 220 of the central anode A₁, and LWAₙ is the loading weight of the anode active material layer 220 of the outermost anode Aₙ. In addition, SCA₁ is the specific capacity of the anode active material of the central anode A₁, and SCAₙ is the specific capacity of the anode active material of the outermost anode Aₙ.

In an embodiment, a ratio of LWAₙ×SCAₙ to LWA₁×SCA₁ may be 0.75 or more and less than 1.3, 0.75 to 1.3, 0.75 to 1.25, 0.8 to 1.2, 0.9 to 1.1, or 0.95 to 1.05.

0.7×(LWA₁×SCA₁)≤LWAₖ×SCAₖ≤1.3×(LWA₁×SCA₁) Equation 6-2

In Equation 6-2, LWA₁ is the loading weight of the anode active material layer 220 of the central anode A₁, and LWAₖ is the loading weight of the anode active material layer 220 of the k-th anode. SCA₁ is the specific capacity of the anode active material of the central anode A₁, and SCAₖ is the specific capacity of the anode active material of the k-th anode. k is an integer from 2 to n, and n is an integer of 3 or more.

In an embodiment, a ratio of LWAₖ×SCAₖ to LWA₁×SCA₁ may be 0.75 or more and less than 1.3, 0.75 to 1.3, 0.75 to 1.25, 0.8 to 1.2, 0.9 to 1.1, or 0.95 to 1.05.

In an embodiment, the cathode active material layer 120 of the central cathode C₁ may be formed in a multilayer. Also, the cathode active material layer 120 of the outermost cathode Cₘ may be formed in a single layer.

In an embodiment, the central cathode C₁ may include a first cathode active material layer 121 formed on the cathode current collector 110 and a second cathode active material layer 122 formed on the first cathode active material layer 121. The first cathode active material layer 121 may include a first cathode active material, and the second cathode active material layer 122 may include a second cathode active material having a specific capacity smaller than that of the first cathode active material. Accordingly, the capacity and life-span characteristics of the battery may be further improved.

In an embodiment, each of the inner cathodes (e.g., the first cathode C₁ to the m−1-th cathode Cₘ₋₁) may include the first cathode active material layer 121 and the second cathode active material layer 122.

In an embodiment, a ratio of the specific capacity of the cathode active material of the outermost cathode Cₘ to the specific capacity of the first cathode active material may be 0.9 to 1.1, or 0.95 to 1.05. In an embodiment, the specific capacity of the first cathode active material and the specific capacity of the cathode active material of the outermost cathode Cₘ may be substantially the same as each other. In this case, the non-uniformity in deterioration of the battery may be further alleviated.

In an embodiment, the specific capacity of the second cathode active material may be smaller than the specific capacity of the cathode active material of the outermost cathode Cₘ.

In an embodiment, a ratio of the specific capacity of the second cathode active material to the specific capacity of the cathode active material of the outermost cathode Cₘ may be 0.1 to 0.9, 0.2 to 0.8, 0.3 to 0.7, or 0.4 to 0.6.

In an embodiment, a ratio of the loading weight of the second cathode active material layer 122 to the loading weight of the first cathode active material layer 121 may be 0.1 to 10.

In an embodiment, a ratio of the loading weight of the cathode active material layer 120 of the outermost cathode Cₘ to the loading weight of the first cathode active material layer 121 may be 0.9 to 1.1, or 0.95 to 1.05. In this case, the non-uniformity in deterioration of the battery may be further alleviated.

In an embodiment, the loading weight of the first cathode active material layer 121 and the loading weight of the cathode active material layer 120 of the outermost cathode Cₘ may be substantially the same as each other.

For example, when the loading weights of the cathode active material layers 121 and 122 of the central cathode C₁ and the specific capacity of the cathode active material of the central cathode C₁ satisfy the above conditions, the non-uniformity in deterioration of the battery may be further alleviated. Accordingly, the life-span characteristics of the battery may be further improved.

In an embodiment, the anode active material layer 220 of the central anode A₁ may be formed in a multilayer. Also, the anode active material layer 220 of the outermost anode Aₙ may be formed in a single layer.

In an embodiment, the central anode A₁ may include a first anode active material layer 221 formed on the anode current collector 210 and a second anode active material layer 222 formed on the first anode active material layer 221. The first anode active material layer 221 may include a first anode active material, and the second anode active material layer 222 may include a second anode active material having a specific capacity smaller than that of the first anode active material. Accordingly, the capacity and life-span characteristics of the battery may be further improved.

In an embodiment, each of the inner anodes (e.g., the first anode A₁ to the n−1-th anode Aₙ₋₁) may include the first anode active material layer 221 and the second anode active material layer 222.

In an embodiment, the specific capacity of the anode active material included in the first anode active material layer 221 may be greater than the specific capacity of the anode active material included in the second anode active material layer 222. In this case, the capacity and life-span characteristics of the battery may be further improved.

In an embodiment, a ratio of the specific capacity of the anode active material of the outermost anode Aₙ to the specific capacity of the first anode active material may be 0.9 to 1.1, or 0.95 to 1.05. In an embodiment, the specific capacity of the first anode active material and the specific capacity of the anode active material of the outermost anode Aₙ may be substantially the same as each other. In this case, the non-uniformity in deterioration of the battery may be further alleviated.

In an embodiment, the specific capacity of the second anode active material may be smaller than that of the anode active material of the outermost anode Aₙ.

In an embodiment, a ratio of the specific capacity of the second anode active material to the specific capacity of the anode active material of the outermost anode Aₙ may be 0.1 to 0.9, 0,2 to 0.8, 0.3 to 0.7, or 0.4 to 0.6.

In an embodiment, a ratio of the loading weight of the second anode active material layer 222 to the loading weight of the first anode active material layer 221 may be 0.1 to 10.

In an embodiment, a ratio of the loading weight of the anode active material layer 220 of the outermost anode Aₙ to the loading weight of the first anode active material layer 221 may be 0.9 to 1.1, or 0.95 to 1.05. In this case, the non-uniformity in deterioration of the battery may be further alleviated.

In an embodiment, the loading weight of the first anode active material layer 221 and the loading weight of the anode active material layer 220 of the outermost anode Aₙ may be substantially the same as each other.

For example, when the loading weights of the anode active material layers 221 and 222 of the central anode A₁ and the specific capacity of the anode active material of the central anode A₁ satisfy the above-described conditions, the non-uniformity in deterioration of the battery may be further alleviated. Accordingly, the life-span characteristics of the battery may be further improved.

In an embodiment, a ratio of the loading weight of the anode active material layer 220 of the k-th anode to the loading weight of the cathode active material layer 120 of the k-th cathode (i.e., N/P ratio) may be 0.7 to 1.3.

In an embodiment, the electrode assembly 20 may further include separation membranes 300 which are disposed between the cathodes and the anodes, respectively.

For example, the separation membrane 300 may include a porous polymer film made of a polyolefin polymer such as polyethylene, polypropylene, ethylene-butene copolymer, ethylene-hexene copolymer, or ethylene-methacrylate copolymer.

In an embodiment, the separation membrane 300 may include a nonwoven fabric made glass fiber having a high melting point, polyethylene terephthalate fiber or the like.

In an embodiment, the lithium secondary battery 10 may further include a cathode tab 130 protruding from one side of the cathode current collector 110. In an embodiment, the lithium secondary battery 10 may further include a cathode lead 140 electrically connected to the cathode tab 130. For example, the cathode tab 130 may be formed integrally with the cathode current collector 110, or electrically connected to the cathode current collector 110 by welding or the like.

In an embodiment, the lithium secondary battery 10 may further include an anode tab 230 protruding from one side of the anode current collector 210. In an embodiment, the lithium secondary battery 10 may further include an anode lead 240 electrically connected to the anode tab 230. For example, the anode tab 230 may be formed integrally with the anode current collector 210, or electrically connected to the anode current collector 210 by welding or the like.

In an embodiment, the lithium secondary battery 10 may further include an electrolyte housed in the case 30 together with the electrode assembly 150.

In an embodiment, the electrolyte may include a lithium salt and an organic solvent.

For example, the lithium salt may include Li⁺X⁻. For example, X⁻ may be at least one of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

For example, the organic solvent may include a carbonate solvent such as ethylene carbonate (EC), propylene carbonate (PC), dimethyl carbonate (DMC), diethyl carbonate (DEC), ethyl methyl carbonate (EMC), etc.; an ester (carboxylate) solvent such as methyl propionate, ethyl propionate, ethyl acetate, propyl acetate, butyl acetate, butyrolactone, caprolactone, valerolactone, etc.; an ether solvent such as dibutyl ether, tetraethylene glycol dimethyl ether, diethylene glycol dimethyl ether, tetrahydrofuran, etc.; a ketone solvent such as cyclohexanone, etc.; an alcohol solvent such as ethyl alcohol, isopropyl alcohol, etc.; and an aprotic solvent such as an amide solvent, a dioxolane solvent, a sulfolane solvent, a nitrile solvents, etc. These may be used alone or in combination of two or more thereof.

Hereinafter, examples and comparative examples of the present invention will be described. However, the following examples are only examples of the present invention, and the present invention is not limited thereto.

### Example 1

(1) Preparation of Cathode

A first cathode slurry was prepared by dispersing a cathode active material (LiNi_{0.8}Co_{0.1}Mn_{0.1}O₂), carbon nanotubes, and PVDF in N-methyl-2-pyrrolidone in a weight ratio of 98:1:1.

A second cathode slurry was prepared by dispersing a cathode active material (LiNi_{0.9}Co_{0.05}Mn_{0.05}O₂), carbon nanotubes, and PVDF in N-methyl-2-pyrrolidone in a weight ratio of 98:1:1.

A cathode was prepared by applying the first cathode slurry to a region of an Al foil having a protrusion part (i.e., a cathode tab) on one side except for the protrusion part to form a cathode active material layer. The prepared first cathode slurry was used to prepare a first cathode C₁, a second cathode C₂ and a third cathode C₃.

A fourth cathode C₄ was prepared using the second cathode slurry.

The loading weights (g/cm²) of the cathode active material layers and the specific capacities (mAh/g) of the cathode active materials of the first cathode C₁ to the fourth cathode C₄ are as listed in Table 1 below.

(2) Preparation of Anode

A first anode slurry was prepared by dispersing an anode active material (a mixture of artificial graphite and Si, 90:10 w/w), carbon nanotubes, SBR, and CMC in distilled water in a weight ratio of 95:3:1:1.

A second anode slurry was prepared by dispersing an anode active material (a mixture of artificial graphite and Si, 97:3 w/w), carbon nanotubes, SBR, and CMC in distilled water in a weight ratio of 95:3:1:1.

An anode was prepared by applying the first anode slurry to a region of a Cu foil having a protrusion part (i.e., an anode tab) on one side except for the protrusion part to form an anode active material layer. The prepared first anode slurry was used to make first to fourth anodes A₁ to A₄.

A fifth anode A₅ was prepared using the second anode slurry.

The loading weights (g/cm²) of the anode active material layers and the specific capacities (mAh/g) of the anode active materials of the first anode A₁ to the fifth anode A₅ are as described in Table 1 below.

(3) Manufacture of Lithium Secondary Battery

One first anode A₁, a pair of second anodes A₂ to a pair of fifth anodes A₅, and a pair of first cathodes C₁ to a pair of fourth cathodes C₄ are laminated as shown in FIG. 2 to form an electrode assembly. When laminating the cathodes and the anodes, polyethylene separation membranes were interposed between the cathodes and the anodes.

A 1 M LiPF₆ (lithium hexafluorophosphate) solution in a mixed solvent of EC/EMC of 3:7 v/v was prepared. In the LiPF₆ solution, based on the total weight of the electrolyte, 1 wt. % of fluoroethylene carbonate (FEC), 1 wt. % of LiPO₂F₂, 0.5 wt. % of 1,3-propane sultone (PS) and 0.5 wt. % of prop-1-ene-1,3-sultone (PRS) were mixed to prepare an electrolyte.

A cathode lead and an anode lead were connected to the cathode tabs and the anode tabs by welding. The electrode assembly was housed in a pouch so that some regions of the cathode lead and the anode lead were exposed to an outside, followed by sealing three sides of the pouch except for a side of an electrolyte injection part.

A lithium secondary battery was manufactured by inputting the prepared electrolyte into the pouch and sealing the side of the electrolyte injection part.

### Examples 2 to 4, and Comparative Examples 1 and 2

Lithium secondary batteries were manufactured by performing the same procedures as described in Example 1, except that the loading weights of the cathode active material layer and the anode active material layer, and specific capacities of the cathode active material and the anode active material were differently adjusted as listed in Table 1 below.

The specific capacity of the cathode active material was adjusted by using cathode active materials having different Ni content (mol fraction), and the specific capacity of the anode active material was adjusted by using anode active materials having different Si content (wt. %).

### Example 5

The second cathode slurry and the first cathode slurry were sequentially applied to an Al foil to prepare a cathode including a cathode active material layer having a two-layer structure. The prepared cathode was used as a first cathode to a third cathode.

The second anode slurry and the first anode slurry were sequentially applied to a Cu foil to prepare an anode including an anode active material layer having a two-layer structure. The prepared anode was used as a first anode to a fourth anode.

A lithium secondary battery was manufactured by performing the same procedures as described in Example 1 except for the above process.

### Experimental Example 1: Evaluation of Life-Span Characteristics (Capacity Retention Rate)

The batteries of the examples and comparative examples were CC/CV (constant current/constant volume) charged (0.5C 4.3 V, 0.05C CUT-OFF) and CC discharged (0.5C 2.7 V CUT-OFF).

The charging and discharging were repeatedly performed 500 times on the batteries, and a discharge capacity D3 at the third time and a discharge capacity D500 at the 500th time were measured.

The capacity retention rate was calculated by the following equation.

Capacity retention rate (%)=D₅₀₀/D₃×100(%)

### Experimental Example 2: Evaluation of Rapid Charging Performance

The batteries of the examples and comparative examples were charged at 0.33C (at a current rate equal to 0.33 times its capacity) up to a state of charge (SOC) of 8%, charged at 2.5C(8-20%)-2.25C(20-32%)-2C(32-44%)-1.75C(44-56%)-1.5C(56-68%)-1.0C(68-80%) stage by stage in a section of SOC 8-80%, and charged at 0.33C (4.3 V, 0.05C CUT-OFF) in a section of SOC 80-100%, then discharged (0.33C 2.7 V CUT-OFF).

The charge and discharge were repeated 100 times, and a discharge capacity Q₁ at the first time and a discharge capacity Q₁₀₀ at the 100th time were measured.

The rapid charge capacity retention rate was calculated by the following equation.

Rapid charge capacity retention rate (%)=Q₁₀₀/Q₁×100(%)

### Experimental Example 3: Evaluation Heat Generation

After the rapid charging performance evaluation, temperatures of the batteries were measured.

TABLE 1

| | | | | | | | Comp. | Comp. |
|---|---|---|---|---|---|---|---|---|
| | | Ex. 1 | Ex. 2 | Ex. 3 | Ex. 4 | Ex. 5 | Ex. 1 | Ex. 2 |
| A1 | Loading | 10 | 10 | 10 | 10 | Lower | 10 | 10 |
| | weight | | | | | layer: 5 | | |
| | (mg/cm²) | | | | | Upper | | |
| | | | | | | layer: 5 | | |
| | Specific | 350 | 350 | 350 | 350 | Lower | 350 | 350 |
| | capacity | | | | | layer: 700 | | |
| | (mAh/g) | | | | | Upper | | |
| | | | | | | layer: 350 | | |
| C1 | Loading | 20 | 20 | 20 | 20 | Lower | 20 | 20 |
| | weight | | | | | layer: 17.5 | | |
| | (mg/cm²) | | | | | Upper | | |
| | | | | | | layer: 2.5 | | |
| | Specific | 170 | 170 | 170 | 170 | Lower | 170 | 170 |
| | capacity | | | | | layer: 200 | | |
| | (mAh/g) | | | | | Upper | | |
| | | | | | | layer: 170 | | |
| A2 | Loading | 10 | 8.75 | 10 | 10 | Lower | 10 | 10 |
| | weight | | | | | layer: 5 | | |
| | (mg/cm²) | | | | | Upper | | |
| | | | | | | layer: 5 | | |
| | Specific | 350 | 400 | 350 | 350 | Lower | 350 | 350 |
| | capacity | | | | | layer: 700 | | |
| | (mAh/g) | | | | | Upper | | |
| | | | | | | layer: 350 | | |
| C2 | Loading | 20 | 19.4 | 20 | 20 | Lower | 20 | 20 |
| | weight | | | | | layer: 17.5 | | |
| | (mg/cm²) | | | | | Upper | | |
| | | | | | | layer: 2.5 | | |
| | Specific | 170 | 180 | 170 | 170 | Lower | 170 | 170 |
| | capacity | | | | | layer: 200 | | |
| | (mAh/g) | | | | | Upper | | |
| | | | | | | layer: 170 | | |
| A3 | Loading | 10 | 7 | 10 | 10 | Lower | 10 | 10 |
| | weight | | | | | layer: 5 | | |
| | (mg/cm²) | | | | | Upper | | |
| | | | | | | layer: 5 | | |
| | Specific | 350 | 500 | 350 | 350 | Lower | 350 | 350 |
| | capacity | | | | | layer: 700 | | |
| | (mAh/g) | | | | | Upper | | |
| | | | | | | layer: 350 | | |
| C3 | Loading | 20 | 18.4 | 20 | 20 | Lower | 20 | 20 |
| | weight | | | | | layer: 17.5 | | |
| | (mg/cm²) | | | | | Upper | | |
| | | | | | | layer: 2.5 | | |
| | Specific | 170 | 190 | 170 | 170 | Lower | 170 | 170 |
| | capacity | | | | | layer: 200 | | |
| | (mAh/g) | | | | | Upper | | |
| | | | | | | layer: 170 | | |
| A4 | Loading | 10 | 5.8 | 10 | 10 | Lower | 10 | 10 |
| | weight | | | | | layer: 5 | | |
| | (mg/cm²) | | | | | Upper | | |
| | | | | | | layer: 5 | | |
| | Specific | 350 | 600 | 350 | 350 | Lower | 350 | 350 |
| | capacity | | | | | layer: 700 | | |
| | (mAh/g) | | | | | Upper | | |
| | | | | | | layer: 350 | | |
| C4 | Loading | 17.5 | 17.5 | 12.3 | 22.8 | 17.5 | 15 | 20 |
| | weight | | | | | | | |
| | (mg/cm²) | | | | | | | |
| | Specific | 200 | 200 | 200 | 200 | 200 | 170 | 200 |
| | capacity | | | | | | | |
| | (mAh/g) | | | | | | | |
| A5 | Loading | 5 | 5 | 3.5 | 6.5 | 5 | 7.3 | 10 |
| | weight | | | | | | | |
| | (mg/cm²) | | | | | | | |
| | Specific | 700 | 700 | 700 | 700 | 700 | 350 | 700 |
| | capacity | | | | | | | |
| | (mAh/g) | | | | | | | |

TABLE 2

| | | Rapid charge | Rapid charge |
|---|---|---|---|
| | Capacity | capacity | battery |
| | retention rate | retention rate | temperature at |
| | at 500 Cycle | at 100 Cycle | 100 Cycle |
| | (%) | (%) | (° C.) |
| Example 1 | 97 | 95 | 34 |
| Example 2 | 97 | 96 | 33 |
| Example 3 | 94 | 90 | 36 |
| Example 4 | 93 | 87 | 39 |
| Example 5 | 98 | 96 | 33 |
| Comparative | 90 | 85 | 48 |
| Example 1 | | | |
| Comparative | 92 | 86 | 52 |
| Example 2 | | | |

Referring to Table 2, the lithium secondary batteries of the examples had improved life-span characteristics and rapid charge capacity retention rates compared to the lithium secondary batteries of the comparative examples.

In addition, the lithium secondary battery of the examples had a lower battery temperature after rapid charging than the lithium secondary batteries of the comparative examples.

What is claimed is:

1. A lithium secondary battery comprising:
an electrode assembly including a plurality of cathodes and a plurality of anodes, which are alternately and repeatedly laminated; and
a case in which the electrode assembly is housed,
wherein each of the plurality of cathodes comprises a cathode current collector, and a cathode active material layer formed on the cathode current collector and including a cathode active material,
each of the plurality of cathodes comprises a central cathode located at or adjacent to a center area of the electrode assembly in a thickness direction, and outermost cathodes located farthest from the center area of the electrode assembly in the thickness direction,
wherein each of the plurality of anodes comprises an anode current collector, and an anode active material layer formed on the anode current collector and including an anode active material,
each of the plurality of anodes comprises a central anode located at or adjacent to the center area of the electrode assembly in the thickness direction, and outermost anodes located farthest from the center area of the electrode assembly in the thickness direction,
wherein a loading weight (LWC₁) of the cathode active material layer of the central cathode is greater than a loading weight (LWCₘ) of a cathode active material layer of each of the outermost cathodes, and a specific capacity (SCC₁) of the cathode active material of the central cathode is smaller than a specific capacity (SCCₘ) of a cathode active material in the cathode active material layer of each of the outermost cathodes, and
a loading weight (LWA₁) of an anode active material layer of the central anode is greater than a loading weight (LWAₙ) of an anode active material layer of each of the outermost anodes, and a specific capacity (SCA₁) of an anode active material in the anode active material layer of the central anode is smaller than a specific capacity (SCAₙ) of an anode active material in the anode active material layer of each of the outermost anodes.

2. The lithium secondary battery according to claim 1, wherein a ratio of LWCₘ to LWC₁ is 0.6 to 0.9.

3. The lithium secondary battery according to claim 1, wherein a ratio of SCCₘ to SCC₁ is 1.1 to 5.

4. The lithium secondary battery according to claim 1, wherein a ratio of a value of LWCₘ×SCCₘ to a value of LWC₁×SCC₁ is 0.7 to 1.3.

5. The lithium secondary battery according to claim 1, wherein the cathode active material layer of the central cathode comprises:
a first cathode active material layer formed on the cathode current collector of the central cathode and including a first cathode active material; and a second cathode active material layer formed on the first cathode active material layer and including a second cathode active material,
wherein a specific capacity (SCC₁₋₁) of the first cathode active material is greater than a specific capacity (SCC₁₋₂) of the second cathode active material.

6. The lithium secondary battery according to claim 5, wherein a ratio of SCCₘ to SCC₁₋₁ is 0.95 to 1.05, and a ratio of SCC₁₋₂ to SCCₘ is 0.1 to 0.9.

7. The lithium secondary battery according to claim 1, wherein the case comprises a first surface and a second surface, which face each other in the thickness direction of the electrode assembly,
the plurality of cathodes comprise a single or a pair of first cathodes to a pair of m-th cathodes, which are arranged in both directions from the center area of the electrode assembly in the thickness direction toward the first surface and the second surface of the case, provided that m is an integer of 3 or more,
the first cathode is the central cathode, and
the m-th cathodes are the outermost cathodes.

8. The lithium secondary battery according to claim 7, wherein the plurality of cathodes satisfy Equation 1-1 below:
LWC₁>. . . >LWCₖ₋₁>LWCₖ Equation 1-1
wherein in Equation 1-1, LWCₖ is a loading weight of a cathode active material layer of a k-th cathode, and k is an integer from 2 to m.

9. The lithium secondary battery according to claim 7, wherein the plurality of cathodes satisfy Equation 3-1 below:
SCC₁<. . . <SCCₖ₋₁<SCCₖ Equation 3-1
wherein in Equation 3-1, SCCₖ is a specific capacity of a cathode active material included in the cathode active material layer of the k-th cathode, and k is an integer from 2 to m.

10. The lithium secondary battery according to claim 7, wherein the plurality of cathodes satisfy Equation 5-2 below:
0.7×(LWC₁×SCC₁)≤LWCₖ×SCCₖ≤1.3×(LWC₁×SCC₁) Equation 5-2
wherein in Equation 5-2, LWCₖ is the loading weight of the cathode active material layer of the k-th cathode, SCCₖ is the specific capacity of the cathode active material included in the cathode active material layer of the k-th cathode, k is an integer from 2 to m, and m is an integer of 3 or more.

11. The lithium secondary battery according to claim 1, wherein a ratio of LWAₙ to LWA₁ is 0.1 to 0.9.

12. The lithium secondary battery according to claim 1, wherein a ratio of SCAₙ to SCA₁ is 1.1 to 10.

13. The lithium secondary battery according to claim 1, wherein a ratio of a value of LWAₙ×SCAₙ to a value of LWA₁×SCA₁ is 0.7 to 1.3.

14. The lithium secondary battery according to claim 1, wherein the anode active material layer of the central anode comprises:
a first anode active material layer formed on an anode current collector of the central anode and including a first anode active material; and a second anode active material layer formed on the first anode active material layer and including a second anode active material;
wherein a specific capacity (SCA₁₋₁) of the first anode active material is greater than a specific capacity (SCA₁₋₂) of the second anode active material.

15. The lithium secondary battery according to claim 14, wherein a ratio of SCAₙ to SCA₁₋₁ is 0.95 to 1.05, and a ratio of SCA₁₋₂ to SCAₙ is 0.1 to 0.9.

16. The lithium secondary battery according to claim 1, wherein the case comprises a first surface and a second surface, which face each other in the thickness direction of the electrode assembly,
the plurality of anodes comprise a single or a pair of first anodes to a pair of the n-th anodes, which are arranged in both directions from the center area of the electrode assembly in the thickness direction toward the first surface and the second surface of the case, provided that n is an integer greater of 3 or more,
the first anode is the central anode, and
the n-th anodes are the outermost anodes.

17. The lithium secondary battery according to claim 16, wherein the plurality of anodes satisfy Equation 2-1 below:
LWA₁>. . . >LWAₖ₋₁>LWAₖ Equation 2-1
wherein in Equation 2-1, LWAₖ is a loading weight of an anode active material layer of a k-th anode, and k is an integer from 2 to n.

18. The lithium secondary battery according to claim 16, wherein the plurality of anodes satisfy Equation 4-1 below:
SCA₁<. . . <SCAₖ₋₁<SCAₖ Equation 4-1
wherein in Equation 4-1, SCAₖ is a specific capacity of an anode active material included in the anode active material layer of the k-th anode, and k is an integer from 2 to n.

19. The lithium secondary battery according to claim 16, wherein the plurality of anodes satisfy Equation 6-2 below:
0.7×(LWA₁×SCA₁)≤LWAₖ×SCAₖ≤1.3×(LWA₁×SCA₁) Equation 6-2
wherein in Equation 6-2, LWAₖ is the loading weight of the anode active material layer of the k-th anode, SCAₖ is the specific capacity of the anode active material included in the anode active material layer of the k-th anode, k is an integer from 2 to n, and n is an integer of 3 or more.
